(19) United States
(12) Patent Application Publication
(10) Pub. No.: US 2014/0069315 A1
(43) Pub. Date: Mar. 13, 2014

(54) ROTATION TRANSFER SYSTEM FOR CHANGE RINGING BELLS

(71) Applicants: Thomas Ward Farthing, Naperville, IL (US); Frank George Farthing, Kalamazoo, MI (US)

(72) Inventors: Thomas Ward Farthing, Naperville, IL (US); Frank George Farthing, Kalamazoo, MI (US)

(21) Appl. No.: 13/609,177

(22) Filed: Sep. 10, 2012

(51) Int. Cl. G10K 1/34

(52) U.S. Cl. 116/150; 116/172

(57) ABSTRACT

A rotation transfer system for change ringing bells or other swinging bells eliminates the need to elevate the bell. With the rotation transfer system, instead of placing the swinging bells several feet above the ringer, they can be placed at the same level as the ringer. If the bells (and the ringer) are at ground level, the force of the swinging bells can be transferred directly to the ground, removing the need for a strong and expensive support structure.

### BACKGROUND OF THE INVENTION

The present invention relates to apparatus for change ringing bells and other swinging bells and, more particularly, to a rotation transfer system that eliminates the need to elevate the bell for change ringing and other swinging bell ringing.

Change ringing is a team sport, a highly coordinated musical performance, an antique art, and a demanding exercise that involves a group of people ringing rhythmically a set of tuned bells through a series of changing sequences that are determined by mathematical principles and executed according to learned patterns.

Current change ringing bells are supported several feet directly above the person controlling the bell, with a rope hanging down from the wheel to the ringer. When the bells are located in a tower, the tower must be built with sufficient strength to withstand the great sideways and downward force of the swinging bells. Making a sufficiently strong tower for several large, heavy bells can be expensive.

Similarly, light-weight dumbbells used for instruction and demonstration can be constructed with the dumbbell overhead, but the support structure is difficult to move and cumbersome.

As can be seen, there is a need for an improved system of change ringing bells that can eliminate the need to elevate the bells or dumbbells and permitting a simple and cost effective installation.

### SUMMARY OF THE INVENTION

In one aspect of the present invention, a rotation transfer system comprises an intermediate spool; a ringer's pull rope having a first end connected to the intermediate spool, the ringer's pull rope wound about and having a second, opposite end extending from the intermediate spool; a bell wheel operable to turn a bell; and a spool to bell wheel connecting rope interconnecting the intermediate spool to the bell wheel such that pulling the ringer's pull rope causes the bell wheel to rotate.

In another aspect of the present invention, a rotation transfer system comprises an intermediate spool disposed above a floor surface; a ringer's pull rope having a first end connected to the intermediate spool, the ringer's pull rope wound about and having a second, opposite end extending from the intermediate spool; a bell wheel operable to rotate about a shaft and turn a bell; a frame supporting the bell wheel, the frame disposed on the floor surface; and a spool to bell wheel connecting rope interconnecting the intermediate spool to the bell wheel such that pulling the ringer's pull rope causes the bell wheel to rotate.

In a further aspect of the present invention, a method for ringing a swinging bell comprises pulling a ringer's pull rope connected to and wrapped about an intermediate spool; and rotating a bell wheel via a spool to bell wheel connecting rope that interconnects the bell wheel with the intermediate spool, wherein the swinging bell is attached to the bell wheel.

These and other features, aspects and advantages of the present invention will become better understood with reference to the following drawings, description and claims.

### BRIEF DESCRIPTION OF THE DRAWINGS

FIG. 1 is a perspective view of a rotation transfer system for change ringing bells according to an exemplary embodiment of the present invention;

FIG. 2 is a side view of the rotation transfer system of FIG. 1; and

FIG. 3 is an end view of the rotation transfer system of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a rotation transfer system for change ringing bells or other swinging bells that eliminates the need to elevate the bell. With the rotation transfer system, instead of placing the swinging bells several feet above the ringer, they can be placed at the same level as the ringer. If the bells (and the ringer) are at ground level, the force of the swinging bells can be transferred directly to the ground, removing the need for a strong and expensive support structure.

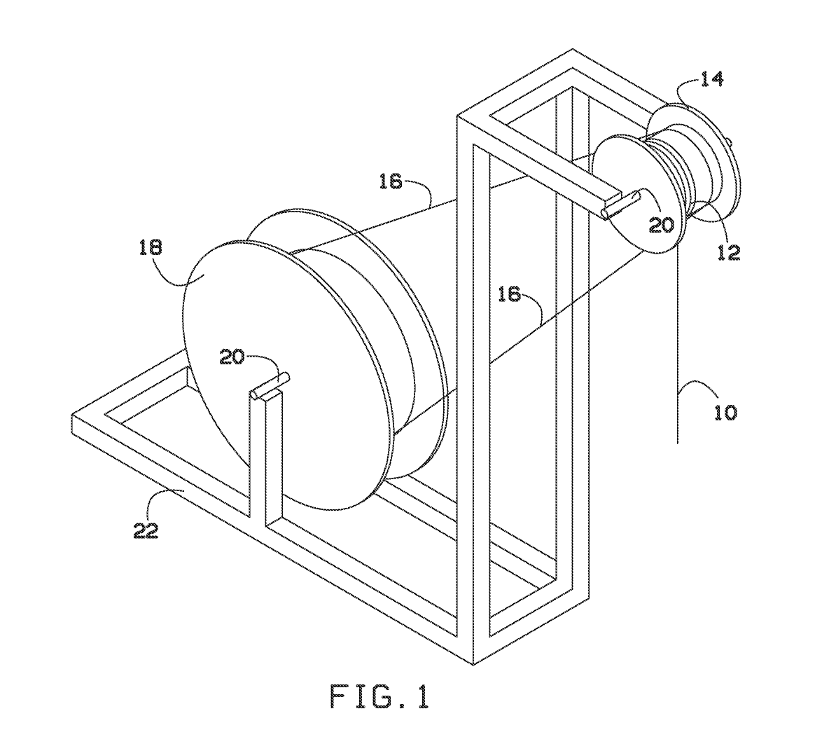

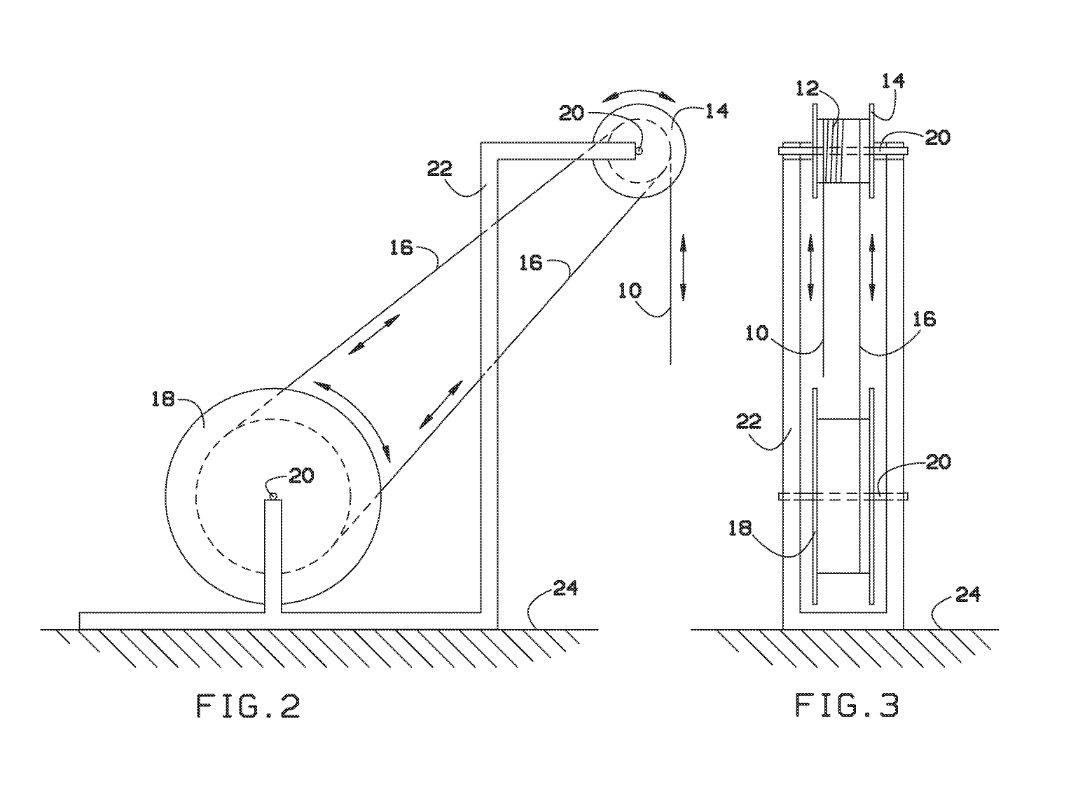

Referring now to FIGS. 1 through 3, a ringer's pull rope 10 can rise from the ringer (not shown) as with existing change ringing bells, but instead of rising to a bell wheel, the ringer's pull rope 10 rises and winds around and attaches to an intermediate spool 14 through a plurality of windings 12. The ringer's pull rope 10 can be fixed to the intermediate spool 14, wind around the intermediate spool 14, and drop down from the intermediate spool 14 to allow the ringer to pull and, thus, rotate a bell wheel 18. The bell wheel 18 can be disposed to rotate about a shaft 20.

A spool to bell wheel connecting rope 16 can wind around both the intermediate spool 14 and the bell wheel 18. As the spool to bell wheel connecting rope 16 unwinds from the intermediate spool 14, the spool to bell wheel connecting rope 16 winds around the bell wheel 18, acting as a pulley rope between the intermediate spool 14 and the bell wheel 18. Alternatively, when the spool to bell wheel connecting rope 16 unwinds from the bell wheel 18, it winds around the intermediate spool 14. This simultaneous winding and unwinding keeps the rope taut.

A support structure 22 can hold the intermediate spool 14 several feet above the floor 24, typically from about 8 to 30 feet above the floor. In some embodiments, the intermediate spool 14 can be attached to a separate structure, such as a ceiling.

When a downward force is applied to the ringer's pull rope 10, the intermediate spool 14 is turned, typically in a clockwise direction and the rotational movement is transferred to the bell wheel 18 by the spool to bell wheel connecting rope 16, rotating a bell (not shown) clockwise. When the downward force is released, the weighted bell swings like a pendulum in a counter-clockwise direction beyond the bottom resting point, such that the ringer's pull rope 10 winds around the intermediate spool 14 more than at the resting point. When the bell has enough momentum, the bell wheel 18 can rotate in a clockwise direction far enough so that the ringer's pull rope 10 completely unwinds from the intermediate spool 14 and winds around the intermediate spool 14 as it rotates in a clockwise direction.

Then, if another downward force is applied to the ringer's pull rope 10, the intermediate spool 14 is turned in a counter-clockwise direction and the bell ringing process is repeated. The tension on the spool to bell wheel connecting rope 16 can be maintained by windings around the intermediate spool 14 and the bell wheel 18.

Instead of building a massively reinforced bell tower, a bell installer could build a relatively inexpensive structure to house traditional metal change ringing bells. The frame 22 to hold each bell would be secured to the floor 24, most likely at ground level, so the force of the swinging bell is transferred to the ground, not to an elevated part of the structure.

A wall can be constructed between the bells and the ringer's pull rope 10 to dampen the sound of the bells. Small holes can be cut in this wall for the spool to bell wheel connecting ropes 16.

Dumbbells that swing like a traditional change ringing bell can be used for training and demonstration purposes. The rotation transfer system of the present invention could be used with such a dumbbell. The mechanical set-up, with the intermediate spool 14, ringer's pull rope 10, spool to bell wheel connection ropes 16, and bell wheel 18 can be the same as described above. The rotation transfer system of the present invention allows for a simpler set up that is easier to erect and is less expensive compared to a dumbbell that is elevated over the ringer's head.

The rotation transfer system of the present invention could also be used for any swinging bell where there would be an advantage to having the bell lower than traditional placements.

It should be understood, of course, that the foregoing relates to exemplary embodiments of the invention and that modifications may be made without departing from the spirit and scope of the invention as set forth in the following claims.

What is claimed is:

1. A rotation transfer system comprising:
an intermediate spool;
a ringer's pull rope having a first end connected to the intermediate spool, the ringer's pull rope wound about and having a second, opposite end extending from the intermediate spool;
a bell wheel operable to turn a bell; and
a spool to bell wheel connecting rope interconnecting the intermediate spool to the bell wheel such that pulling the ringer's pull rope causes the bell wheel to rotate.

2. The rotation transfer system of claim 1, further comprising a frame supporting the bell wheel.

3. The rotation transfer system of claim 2, wherein the frame is disposed on a floor.

4. The rotation transfer system of claim 1, wherein the bell wheel rotates about a shaft.

5. The rotation transfer system of claim 1, wherein the intermediate spool is disposed from about 8 to about 30 feet from a floor surface.

6. A rotation transfer system comprising:
an intermediate spool disposed above a floor surface;
a ringer's pull rope having a first end connected to the intermediate spool, the ringer's pull rope wound about and having a second, opposite end extending from the intermediate spool;
a bell wheel operable to rotate about a shaft and turn a bell;
a frame supporting the bell wheel, the frame disposed on the floor surface; and
a spool to bell wheel connecting rope interconnecting the intermediate spool to the bell wheel such that pulling the ringer's pull rope causes the bell wheel to rotate.

7. The rotation transfer system of claim 6, wherein the intermediate spool is disposed from about 8 to about 30 feet from a floor surface.

8. A method for ringing a swinging bell comprising:
pulling a ringer's pull rope connected to and wrapped about an intermediate spool; and
rotating a bell wheel via a spool to bell wheel connecting rope that interconnects the bell wheel with the intermediate spool, wherein the swinging bell is attached to the bell wheel.

9. The method of claim 8, further comprising supporting the bell wheel with a frame.

10. The method of claim 8, further comprising supporting the frame on a floor surface.
